(19) United States
(12) Patent Application Publication
(10) Pub. No.: US 2007/0136742 A1
(43) Pub. Date: Jun. 14, 2007

(54) Method, apparatus and system for replacing advertisements in recorded video content

(75) Inventor: Carlton J. Sparrell, Marblehead, MA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/302,446

(22) Filed: Dec. 13, 2005

(51) Int. Cl. H04N 7/025; H04N 7/10

(52) U.S. Cl. 725/32; 725/34

(57) ABSTRACT

A system (10), method (60) and apparatus (14) are provided for updating a first advertisement in a video program stream with a second advertisement, based on temporal metadata replacement rules and instructions embedded in or otherwise associated with the advertisements. The system (10) includes a video stream encoder (12) for embedding temporal metadata into the advertisements. The method (60) includes a step (62) of reading the temporal metadata and a step (66) of updating the advertisements based on the temporal metadata. The apparatus (14) includes a recording device (22) for recording (64) portions of the video program stream, including the advertisements. The apparatus (14) also includes an advertisement reader (18) for identifying and locating suitable replacement advertisements based on the temporal metadata, and an advertisement insertion module (24) for replacing advertisements in the stored video program based on the temporal metadata.

### BACKGROUND OF THE INVENTION

1. Field of the Invention

The invention relates to television advertising. More particularly, the invention relates to replacing or updating television advertisements in recorded television video content.

2. Description of the Related Art

Much of today's television content delivered to consumers is time-shifted by any one of a number of video processing and/or recording devices, such as videocassette recorders (VCRs) and, more recently, digital video recorder (DVR) devices, including signal converter or decoder (set-top) boxes with recording capabilities. In a typical time-shifting scenario, a subscriber or end user records a portion of one or more video programs or other delivered content, including the advertising portions thereof, for subsequent playback at a later time.

Conventionally, the insertion of advertisements or advertising programs into video content is performed by either the broadcaster, the content service provider, and/or the local affiliate of the content service provider. In conventional business models, advertising sponsors purchase time during specific shows or specific time slots for showing their advertising programs.

However, many of the advertising programs contain time-sensitive information, and time-shifting by the end user often can reduce the effectiveness of advertising programs if the advertising programs are not played back until much later. Moreover, an advertisement for an event that will occur in the next few days is rendered essentially ineffective if the advertisement is not viewed by the end user until a week later because of time-shifting.

Generally, conventional methods exist that select, deliver and insert video advertising programs into program streams based on various criteria. For example, there are conventional methods that select and deliver customized video advertising programs based on various user preferences or user profiles. Also, there are conventional methods that process video signals by inserting tags during processing of the video signal to allow for later insertion of advertising. Such methods typically are in accordance with various standards, e.g., standards established by the Society of Cable Telecommunications Engineers (SCTE), such as Digital Video Subcommittee (DVS) 629, DVS 630 and DVS 631. Also, conventional methods and system are used for managing resources for recording television content for time-shifted playback.

### BRIEF DESCRIPTION OF THE DRAWINGS

FIG. 1 is a block diagram of a system for updating advertisements in video streams including recorded video streams;

FIG. 2 is a block diagram of an apparatus or portion of an apparatus for updating advertisements in video streams including recorded video streams; and

FIG. 3 is a flow chart of a method for updating advertisements in video streams including recorded video streams.

### DETAILED DESCRIPTION

In the following description, like reference numerals indicate like components to enhance the understanding of the advertisement updating method, apparatus and system through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

Conventional methods for selling advertisements typically involve the association of specific advertising sponsors to certain television programs or programming time slots. Marketing specific programming time slots to potential sponsors often is based on matching demographics associated with specific programs to products appropriate for those demographics.

Although some advertisements are timeless, many advertisements contain time-sensitive information that must be viewed by a certain time or before the occurrence of a certain event to be effective as an advertisement. For example, a merchant's advertisement for an upcoming weekend sale or a network's advertisement for the future broadcast of a particular program should be shown prior to the occurrence of their respective event or else the effectiveness of the advertisement is negated.

The timely showing of time-sensitive advertisements becomes even more critical if the program within which the advertisement is inserted has been recorded for later playback, i.e., time-shifted. The availability of many different video processing devices with recording capabilities allows video content viewers to more easily record broadcast programming for later playback, whether such time-shifting be minutes, hours, days, weeks or even months after the original broadcast of the programming. Such devices include digital video recorder (DVR) devices and set-top boxes with local or remote storage, which often are referred to as personal video recorder (PVR) devices. As such video-recording devices become more commonplace, the ability to update or replace the time-sensitive advertisements originally inserted in recorded programming becomes more needed.

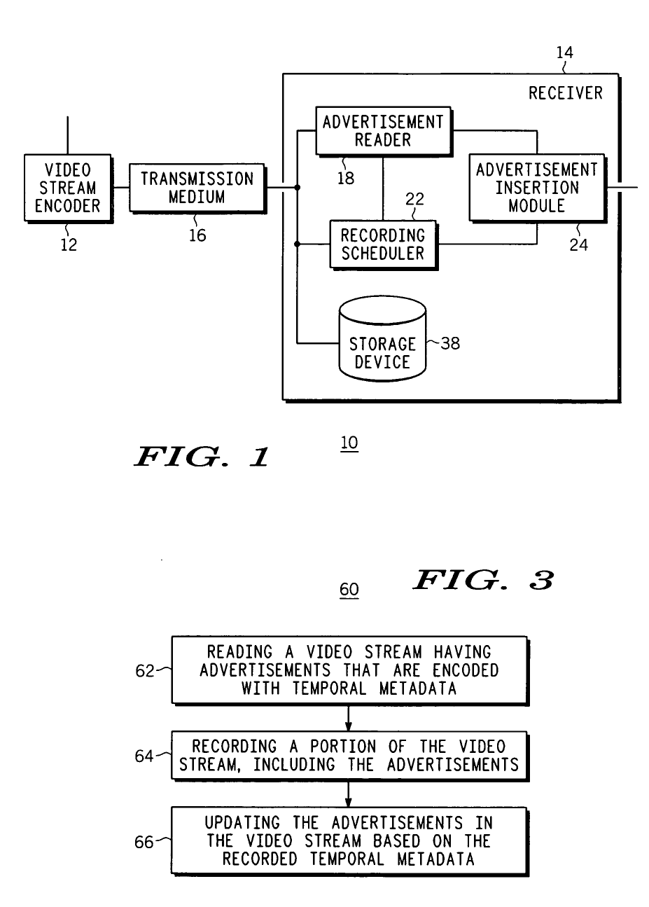

FIG. 1 is a simplified schematic diagram of a system 10 for updating advertisements in video streams including recorded video streams. The system 10 includes an encoder or video stream encoder 12, a receiver or video stream receiver 14, and a transmission medium 16 coupled between the encoder 12 and the receiver 14. The receiver 14 includes an advertisement reader 18, a recording scheduler 22, an advertisement insertion module 24, and a storage device 38.

The encoder 12 has one or more inputs for receiving video streams, such as broadcast programming streams containing television programs and advertisements inserted between different television programs and between portions of the same television program. The video stream typically is a plurality of digital video signals formatted according to a suitable standard, such as the MPEG (Moving Picture Experts Group) 2 or MPEG 4 standard, and multiplexed into a data stream that is modulated on a carrier using quadrature amplitude modulation (QAM) or other suitable modulation technique. The video stream typically is received by the encoder 12 from a digital cable system or other suitable video stream source, such as a Hybrid Fiber Coaxial (HFC) cable system. However, the video stream also can be an analog video stream, or Internet Protocol (IP) video stream transmitted over any suitable Fiber To The Premises (FTTP) system, such as Fiber To The Curb (FTTC) or Fiber To The Home (FTTH), or over any suitable a number of digital subscriber line systems (xDSL).

In the system 10, the encoder 12 typically is located at the service provider, i.e., at the location of the source of the video stream. Alternatively, the encoder 12 is located at a location between the service provider and the transmission medium 16. The service provider can be a television service provider (e.g., a national or local television network), a cable television service provider, a telephone service provider, an Internet service provider, a satellite broadcast system service provider, or other suitable service provider.

The encoder 12 receives the video stream and encodes or embeds metadata information into video stream, e.g., into the advertisement portions of the video stream. In the system 10, the encoder 12 encodes or embeds the metadata according to any suitable encoding or embedding technique. For example, for a television signal formatted according to a National Television System Committee (NTSC) video signal standard, the metadata is embedded in the extended data services (XDS) field of the NTSC-formatted signal according to any suitable standard, such as the EIA-608 standard established by the Electronic Industries Association. Alternatively, in an MPEG-2 transport stream, the metadata can be embedded in the user_data( ) field.

In general, within the context of video streams and video data, metadata refers to information that describes data in such a way that the data can be catalogued, indexed, archived and/or retrieved at some future date. In the system 10, the encoder 12 embeds or otherwise associates temporal metadata with the advertisement portions of the video stream. In the traditional sense, “temporal metadata” refers or relates to any additional details or information available at the time the data was captured or that can be derived from the data as part of the data capture process. However, for purposes of discussion herein, and for purposes of the system 10, the term “temporal metadata” refers to metadata embedded or otherwise associated with advertisements that provides information that relates to or identifies the time-sensitive nature of the content of the information in the advertisement.

For example, for an advertisement for a 3-day sales event that begins two days from the initial showing of the advertisement, the temporal metadata might include at least the starting date of the sales event and the ending date of the sales event. Similarly, for a network advertisement for a particular show that is to be broadcast next week, the temporal metadata might include the specific future broadcast date and time of the show.

In the system 10, the encoder 12 could include other information in the temporal metadata portion of the advertisement. For example, the temporal metadata can contain a unique identifier for the advertiser. Similarly, the temporal metadata can contain a unique identifier for the type of advertisement, e.g., a first identifier if the advertisement is a merchant sale and a second identifier if the advertisement is the future broadcast of a net television show.

The temporal metadata also can contain information identifying the owner, the sponsor or the organization responsible for the distribution of the advertisement. As will be discussed in greater detail hereinbelow, with regard to time and place, the temporal metadata can contain a range of time or range of times for the preferred airing of the advertisement, or the rules of replacement for the particular advertisement, i.e., when the advertisement can be replaced and which advertisements can replace the advertisement.

Other temporal metadata embedded by the encoder 12 can include Universal Resource Locators (URLs), which are used to locate and retrieve advertisements for updating or updated advertisement information. Also, the URLs can be used to locate and retrieve additional or updated replacement rules for the advertisements. Also, the embedded temporal metadata can contain digital signature information or similar information for authentication of the temporal metadata and/or any update information.

The encoder 12 can be comprised of any suitable structure or arrangement, e.g., one or more integrated circuits. Also, the encoder 12 can be completely or partially configured in the form of hardware circuitry and/or other hardware components within a larger device or group of components. Alternatively, the encoder 12 is completely or partially configured in the form of software, e.g., as processing instructions or one or more sets of logic or computer code. In such configuration, the logic or processing instructions typically are stored in a data storage device (not shown), which typically is coupled to a processor or controller (not shown). Both the data storage device and the processor or controller can be included as part of the encoder 12, although such is not necessary. The processor accesses the necessary instructions from the data storage device and executes the instructions or transfers the instructions to the appropriate location within the encoder 12.

The encoder 12 includes one or more outputs that are operably coupled to the transmission medium 16. In the system 10, the transmission medium 16 is any suitable transmission medium that can transmit the encoded video streams from the encoder 12 to the receiver 14. For example, the transmission medium 16 can be one or more fiber optic cables, twisted-wire pairs, and/or coaxial cables. Also, the transmission medium 16 can be air, i.e., wireless transmission.

The encoded video stream transmitted from the encoder 12 is received from the transmission medium 16 by the receiver 14. As will be understood from additional discussion hereinbelow, the receiver 14 can be part of any suitable device or subsystem (or portion thereof) for processing video signals, such as any digital video recorder (DVR) device, including signal converter or decoder (set-top) boxes with recording capabilities and local or remote storage, a residential gateway, or other suitable computing devices or video devices, including internet protocol (IP), satellite and cable digital video recorders, and home media server systems manufactured by Motorola Corp. or other suitable manufacturer.

Generally, the receiver 14 receives the encoded video stream from the encoder 12 via the transmission medium 16. The encoded video stream received by the receiver 14 is directed to the advertisement reader 18 and the recorder/recording scheduler 22. The recorder 22 records all or a part of the contents of the encoded video stream, including one or more of the television programs, advertisements within the same television program and advertisements between different television programs.

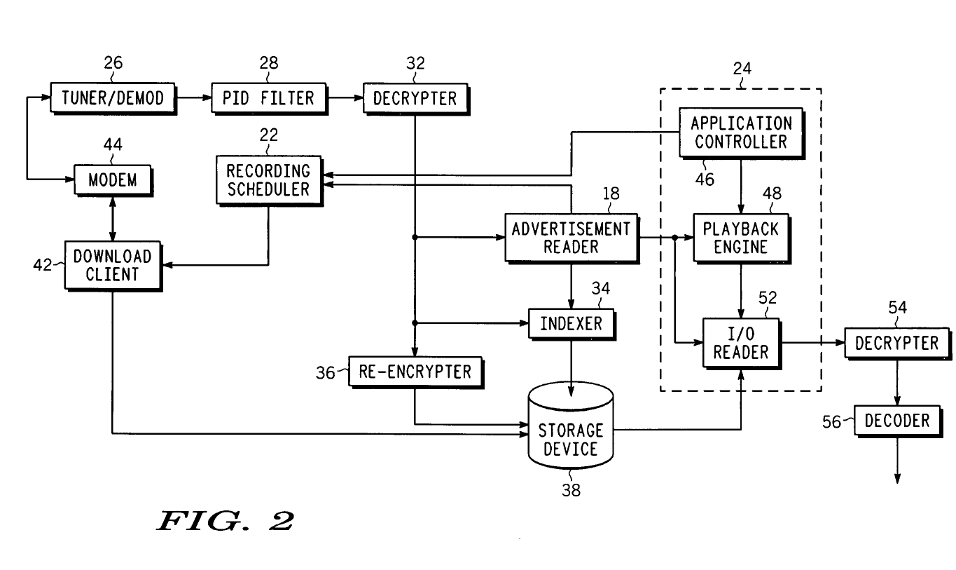

The advertisement reader 18 examines the encoded stream and reads or decodes the temporal metadata embedded in the encoded video stream, typically in the advertisement portions of the video stream. Based on the temporal metadata, the advertisement reader 18 provides advertisement insertion information or instructions and replacement criteria to the advertisement insertion module 24. The advertisement insertion module 24 receives the insertion or replacement information from the advertisement reader 18 and replaces advertisements within and between the stored programs, in general, by controlling the playback of the stored programs and the playback of the advertisements, as will be discussed in greater detail hereinbelow. The receiver 14 is shown in greater detail in FIG. 2 and will be discussed in greater detail hereinbelow.

Referring now to FIG. 2, shown is a simplified schematic diagram of an apparatus or portion of an apparatus for updating advertisements in video streams including recorded video streams. The apparatus shown in FIG. 2 is a more detailed, simplified schematic diagram of the receiver 14 shown in FIG. 1. As discussed hereinabove, the apparatus can be any suitable device or system (or portion thereof) for processing video signals, such as a DVR, a media server system, a residential gateway, or a set-top box.

The apparatus receives the encoded video stream from the encoder 12 (via the transmission medium 16) through a tuner/demodulator 26. As discussed hereinabove, the encoded video stream typically is a QAM-modulated MPEG2 or MPEG4 digital video transport stream from a cable television HFC plant or other source. If the video stream is analog, an MPEG encoder or other suitable encoder (not shown) is included.

From the tuner 26, the MPEG video stream, or other suitably formatted video stream, is filtered by a package identifier (PID) filter 28 for one or more program identifiers of interest. The package identifiers typically are contained in the header portion of the MPEG video stream. The video stream may include a single PID for each program in the video stream. Alternatively, the video stream may include multiple PIDS, e.g., one PID for the main program, another PID for the advertisements, another PID for optional video, and other PIDs for other data.

From the PID filter 28, the video stream typically passes through a decrypter 32 so that the video stream can be properly read by the advertisement reader 18 and properly indexed by an indexer 34. However, it is possible to include in the apparatus an appropriate means for indexing video in its encrypted form. Alternatively, it is possible to provide the video stream in a form that can be decrypted without decrypting the entire video stream. In such case, the decrypter 32 and a subsequent re-encrypter (shown as 36) would be unnecessary.

After the video stream has passed through the decrypter 32, the advertisement reader 18 examines the video stream, looking for advertisements and reading their embedded temporal metadata for advertisement insertion instructions and replacement criteria. The advertisement reader 18 can examine the video stream in real-time, i.e., as the video stream is passing from the decrypter 32 to the re-encrypter 36. Alternatively, the advertisement reader 18 can examine the video stream after portions of the video stream have been recorded. The advertisement reader 18 also is responsible for determining and locating suitable replacement advertisements, whether those replacement advertisements be stored within the apparatus or located external to the apparatus.

As the advertisement reader 18 is reading the video stream, the video stream content also is indexed by an indexer 34. The indexer 34 locates the relatively important spots or locations in the video stream, such as the MPEG start codes or other format start codes. These start codes locate the points within the stream where playback can be started, such as the beginning of an MPEG I-frame or Group Of Pictures (GOP). These start points also serve as entry points for random access into the file (such as jumping back or ahead) and edit points where, for example, one or more advertisements may be inserted, or where the existing advertisements start and end in the video stream. Regardless of whether advertisements are stored together or separately, indexes typically are needed to indicate where in the video stream the advertisements are to be inserted.

From the decrypter 32, the video stream passes to the re-encrypter 36, where the video stream is re-encrypted before being written to a storage device 38. The storage device 38 is any suitable video stream storage device, such as random access memory (RAM), a magnetic hard disk drive, or optical storage media (e.g., optical disks). Also, although the storage device 38 is shown local to the apparatus, the storage device 38 can be located external to the apparatus, e.g., on a separate server or other suitable location that is accessible by the apparatus.

The advertisement insertion module 24 includes an application controller 46, a playback engine 48 and an I/O (input/output) reader 52. The application controller 46 controls the playback of the recorded video content via the playback engine 48. The application controller 46, which also is coupled to the recording scheduler 22, controls which video streams are recorded and controls other recording parameters, such as which channel is tuned.

The recording scheduler 22, which is coupled to the advertisement reader 18 and the advertisement insertion module 24, receives instructions from both as to which programs and advertisements to record. Also, depending on the available resources of the apparatus, the recording scheduler 22 also controls which advertisements from other programs, channels and even external sources get recorded.

The recording scheduler 22 also is coupled to a download client 42 for downloading advertisements not in the video stream, e.g., downloading advertisements through an IP connection. The download client 42 downloads advertisements based on instructions received from the recording scheduler 22. For example, the download client is a File Transfer Protocol (FTP) client. Alternatively, the download client is a Hypertext Transfer Protocol (HTTP) client. The IP connection is established through a modem 44, e.g., a DOCSIS (Data Over Cable Service Interface Specification) modem. Alternatively, the connection is established through any suitable FTTP or xDSL system configuration.

The playback engine 48 receives instructions from the application controller 46 and the advertisement reader 18 as to which video streams to play back, including which (recorded) programs to play back and which advertisements to insert into and between which programs. The playback engine 48 also receives trickplay instructions from the application controller 46. The playback engine 48 also directs the I/O reader 52, which handles the actual input/output duties for the advertisement insertion module 24.

A decrypter 54 is coupled to the advertisement insertion module 24 at the I/O reader 52. The decrypter 54 decrypts the content that has been selected for play back. Coupled to the decrypter 54 is a decoder 56. The decoder 56 decodes the video signals that are to be output from the apparatus, e.g., through a suitable connection, such as a high definition multimedia interface (HDMI) connection (not shown).

As discussed previously herein, the advertisement updating/replacing apparatus (and method), or at least a portion thereof, typically is part of a video processing device, such as a set-top box, a residential gateway, or DVR. Alternatively, the advertisement updating/replacing apparatus (and method) is part of a digital recording and playback system administered by a home area network (HAN). For example, in such arrangement, the system tuner may reside in a set-top box while one or more of the system storage and playback device(s) are remotely located but connected as part of a home area network. As such, the apparatus and method is completely or partially implemented within the video processing device as software or hardware or both. However, alternatively, the apparatus and method can be a complete or partial software and/or hardware upgrade to the video processing device, or a hardware add-on or interface (including software) to the video processing device. Also, the apparatus shown in FIG. 2 can be comprised of any suitable structure or arrangement, e.g., one or more integrated circuits.

The apparatus shown in FIG. 2 can be completely or partially configured in the form of hardware circuitry and/or other hardware components within a larger device or group of components. Alternatively, the apparatus is completely or partially configured in the form of software, e.g., as processing instructions or one or more sets of logic or computer code. In such configuration, the logic or processing instructions typically are stored in a data storage device (e.g., the storage device 38), which typically is coupled to a processor or controller (e.g., the application controller 46). Both the data storage device and the processor or controller are shown included as part of the apparatus, although such is not necessary. The processor accesses the necessary instructions from the data storage device and executes the instructions or transfers the instructions to the appropriate location within the apparatus.

In operation, the apparatus has the advertisement reader 18 read the temporal metadata embedded or otherwise associated with the advertisements contained within or between the programs in the video stream. Based on the information contained in the temporal metadata, the advertisement reader 18 instructs the recording scheduler 22 which programs and advertisements from the video stream to record. Also, based on the information contained in the temporal metadata, the advertisement reader 18 instructs the playback engine 48 which programs are to be played back and also which advertisements are to be inserted into which programs being played back.

As discussed previously herein, the temporal metadata in a given advertisement includes replacement information for that advertisement. Such information includes any time-sensitive information, such as information regarding the date and time by when the advertisement must be shown, or a time window in which the advertisement must be shown. Thus, for example, for an advertisement for a weekend sale at a department store, the temporal metadata for that advertisement can indicate that the advertisement should be shown before the upcoming weekend.

The temporal information also includes the length of the advertisement. Most advertisements are a set increment of time, e.g., thirty seconds or one minute. Therefore, the temporal metadata indicating the advertisement length qualifies advertisement placement based on length. For example, a thirty second advertisement can be replaced by another thirty second advertisement or by two fifteen second advertisements. Similarly, a one minute advertisement can be replaced by another one minute advertisement, two thirty second advertisements, or one thirty second advertisement and 2 fifteen second advertisements.

The temporal information also includes replacement information for that advertisement, i.e., what previously broadcast and stored advertisements the advertisement of interest can replace. Thus, for example, for an advertisement for a weekend sale at a department store, the temporal metadata for the advertisement can indicate that the advertisement is suitable for replacing advertisements in previously-recorded programs that are to be played back before the weekend. Such played back programs may themselves contain advertisements that can be replaced with more current or time-relevant advertisements.

Therefore, depending on the playback time of programs stored and subsequently played back, the temporal metadata provides advertisement updating and insertion criteria. Thus, for any stored advertisement, a set or table of replacement rules may be generated. As new content is being stored, the temporal metadata of the incoming advertisements is compared against the replacement rules of the currently stored advertisements. If the temporal metadata for a new advertisement indicates that the new advertisement is a suitable replacement for a previously recorded advertisement, the new advertisement is stored and linked to the previously recorded advertisement for which the new advertisement is to replace. Such information allows advertisement insertion to be coordinated by the advertisement reader 18 through the recording scheduler 22 and the playback engine 48 portion of the advertisement insertion module 24.

The temporal metadata embedded in the advertisements also can include other information, thus providing additional advertisement insertion instructions and criteria. As discussed previously herein, the temporal metadata can include identifiers unique to advertisers or advertisement sponsors. Such information can establish replacement rules and criteria among advertisements that are owned, paid for or sponsored by the same advertisement entity. For example, such information allows advertisements to be replaced by more recent or current advertisements from the same advertiser or sponsor. Thus, instead of or addition to the time-based element of the content of the advertisement, advertisement insertion can be based on the owner or sponsor of the replacing advertisements and the replaced advertisements.

The temporal metadata embedded in the advertisements also can include identifiers unique to type of advertisement. Thus, similar to identifiers unique to advertisers or sponsors, identifiers unique to type of advertisement can establish replacement rules and criteria based on what type of advertisement is replacing or being replaced. For example, an advertisement for the future broadcast of a network show may be replaced (updated) by a more current advertisement for a network show, whether it be the same network show or a different network show. Similarly, an advertisement for a merchant sale for the upcoming weekend can be replaced by a similar merchant sale, either the same or different sale or the same or different merchant.

Similarly, temporal metadata embedded in the advertisements also can include information related to the type of program into which advertisements are initially inserted or subsequently replaced. Such information can increase the likelihood that an updated advertisement may be found in a subsequent episode of the same show or in a current or subsequent broadcast of a different show. For example, if a particular stored advertisement is a likely candidate for replacement, its temporal metadata can provide information indicating that the advertisement was initially inserted into a particular program or type of program. Thus, the apparatus can use this information to search subsequent broadcasts of that particular program, or programs like it, for possible replacement advertisements. If a suitable replacement advertisement is found, it is recorded and the advertisement to be replaced can be discarded. For searching live broadcasts, the apparatus may use available time when the apparatus is not recording a video stream or engaged in live-pause buffering of currently broadcast video or time-shifted content of previously stored video.

As discussed previously herein, the temporal metadata can include URL information to provide a pointer to potential replacement advertisements. For example, the URL can point to a particular time and channel to look for potential replacement advertisements. Similarly, the URL can point to a repeating timeslot or a particular group of channels to look for potential replacement advertisements. Alternatively, the URL information can point to a Video On Demand (VOD) server for potential replacement advertisements. Similarly, the URL information can point to a web or similar data server over an IP network that allows advertisements to be downloaded to the local storage device 38 or suitable external storage device or location.

Also, as discussed previously herein, the temporal metadata can include a digital signature, a numeric key (i.e., a hashCode), and/or a certification chain. Such information allows the system or apparatus to confirm that the temporal metadata was delivered without error from the encoding source (e.g., the encoder 12) to the local recording device (e.g., the receiver 14). Also, other authentication mechanisms and information can be used to verify the identity of external locations that are contacted for advertisement download, e.g., external IP servers.

The temporal metadata also can include consumption reporting addresses and/or addresses for reporting the consumption or showing of advertisements, e.g., the showing of advertisements as part of a playback of a recorded video stream. The advertisers, sponsors or distributors of the advertisements typically would want to know which advertisements have been shown and when, and which advertisements have been replaced without being shown as part of a video stream playback. The temporal metadata also can provide information about which advertisements have been watched and which advertisements have been skipped over via fast-forwarding. The consumption information can be stored by the system of the apparatus and delivered to an advertiser in any suitable manner, e.g., as the advertisement is consumed or via batch processing, such as weekly or monthly delivery.

Referring now to FIG. 3, with continuing reference to FIG. 2, shown is a flow chart of a method 60 for updating advertisements in video streams including recorded video streams. The method 60 includes a reading step 62, a recording step 64 and an updating step 66. As discussed hereinabove, the reading step 62 examines the encoded video stream and reads the temporal metadata embedded therein. As discussed hereinabove, the temporal metadata contains various information about the advertisements inserted into the programs in the video stream, such as any time-sensitive content in the advertisement, replacement rules for the advertisement, and various advertisement identifying information.

The recording step 64 records all or a part of the encoded video stream. In this manner, the recording step 64 records all or a portion of one or more of the television programs in the video stream, and the advertisements inserted within the television programs and between the television programs. The recording step 64 uses the recording scheduler 22 to determine which portions of the video stream are to be recorded.

The updating or replacing step 66 updates or replaces advertisements in the recorded video stream based on the temporal metadata read by the reading step 62. As discussed hereinabove, the temporal metadata includes advertisement insertion information or instructions, and advertisement replacement criteria. Based on this information, the updating step 66 uses the advertisement insertion module 24 to replace various advertisements in the stored video stream prior to the playback of the video stream.

The method shown in FIG. 3 may be implemented in a general, multi-purpose or single purpose processor. Such a processor will execute instructions, either at the assembly, compiled or machine-level, to perform that process. Those instructions can be written by one of ordinary skill in the art following the description of FIG. 3 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the advertisement updating system, method and apparatus herein described without departing from the spirit and scope of the invention as defined by the appended claims and their full scope of equivalents.

1. A computer program embodied in a computer-readable medium for replacing at least one first advertisement in a video stream with at least one second advertisement, wherein at least one of the first and second advertisements includes temporal metadata associated therewith, the program comprising:
instructions for reading the temporal metadata associated with at least one of the first and second advertisements, wherein replacement instructions for replacing the first advertisement with the second advertisement in the video stream are identified from the temporal metadata; and
instructions for replacing the first advertisement with the second advertisement in the video stream based on the replacement instructions read from the temporal metadata associated with the at least one first and second advertisements.

2. The computer program as recited in claim 1, wherein the second advertisement replaces the first advertisement in the video stream based on the replacement instructions and based on the playback time of the video stream.

3. The computer program as recited in claim 1, wherein the second advertisement replaces the first advertisement in the video stream based on the replacement instructions and based on the owner of the first and second advertisements.

4. The computer program as recited in claim 1, wherein the temporal metadata associated with at least one of the first and second advertisements includes information relating to when the video stream in which the advertisement is inserted should be played, and wherein the replacing instructions further comprise instructions for replacing the first advertisement with the second advertisement based on when the video stream is played.

5. The computer program as recited in claim 1, wherein the reading instructions include instructions for identifying any time-sensitive events associated with the contents of the advertisement for which the temporal metadata is associated, and wherein the replacing instructions further comprise instructions for replacing the first advertisement with the second advertisement based on the identified time-sensitive events.

6. The computer program as recited in claim 1, wherein at least one of the first and second advertisements further comprises a plurality of advertisements, and wherein the replacing instructions includes instructions for determining, based on the metadata associated with at least one of the first and second advertisements, which, if any, of the second advertisements will replace which, if any, of the first advertisements.

7. The computer program as recited in claim 1, wherein the video stream is a recorded video stream, and wherein the second advertisement is recorded subsequent to the recording of at least one of the first advertisement and the video stream.

8. The computer program as recited in claim 1, wherein the video stream is a recorded video stream, and wherein the second advertisement is recorded at a location different from at least one of the first advertisement and the video stream.

9. The computer program as recited in claim 1, wherein the temporal metadata is embedded into the first and second advertisements.

10. An apparatus for controlling the replacement of at least one first advertisement in at least one recorded television program with at least one second advertisement, wherein at least one of the first and second advertisements includes temporal metadata associated therewith, the apparatus comprising:
a recording device for recording at least one television program from a video signal stream, wherein the recorded television program includes the first advertisement;
an advertisement reader coupled to the recording device and configured to read the metadata associated with the first advertisement and, based on the metadata, identify and locate the second advertisement; and
an advertisement insertion module coupled to the advertisement reader and configured to replace the first advertisement with the second advertisement based on instructions from the advertisement reader, the advertisement insertion module including a playback engine that plays the recorded television program.

11. The apparatus as recited in claim 10, wherein at least one of the first and second advertisements further comprises a plurality of advertisements, and wherein the advertisement reader determines, based on the metadata associated with at least one of the first and second advertisements determines, which, if any, of the second advertisements will replace which, if any, of the first advertisements.

12. The apparatus as recited in claim 10, wherein the temporal metadata associated with at least one of the first and second advertisements includes information relating to when the recorded television program in which the advertisement is inserted should be played, and wherein the advertisement insertion module replaces the first advertisement with the second advertisement based on when the recorded television program is played.

13. The apparatus as recited in claim 10, wherein the metadata associated with at least one of the first and second advertisements includes advertisement identification information, and wherein the advertisement insertion module is further configured to confirm which of the first and second advertisements are inserted into the recorded television program when the recorded television program is played.

14. An apparatus for updating a first advertisement in a recorded video stream with at least one of a plurality of second advertisements, wherein at least one of the first advertisement and the plurality of second advertisements includes temporal metadata associated therewith that indicates which of the second advertisements are suitable for replacing the first advertisement, comprising:
a reader for reading the temporal metadata associated with at least one of the first advertisement and the plurality of second advertisements;
a selector for selecting, based on the temporal metadata associated with the first and second advertisement programs, which of the plurality of second advertisements is to update the first advertisement; and
an insertion module for updating the first advertisement with at least one of the selected second advertisements.

15. The apparatus as recited in claim 14, wherein at least one of the reader, the selector and the insertion module is implemented in software executed by a computer.

16. The apparatus as recited in claim 14, wherein at least one of the reader, the selector and the insertion module is implemented in hardware.

17. The apparatus as recited in claim 14, wherein at least a portion of the apparatus is contained in a video processing device.

18. The apparatus as recited in claim 17, wherein the video processing device is selected from the group consisting of a signal converter box, a signal decoder box, a digital video disk recorder, a computer, and a home media server.

19. The apparatus as recited in claim 14, wherein at least a portion of the apparatus further comprises an integrated circuit.
